(19) United States
(12) Patent Application Publication
(10) Pub. No.: US 2007/0294063 A1
(43) Pub. Date: Dec. 20, 2007

(54) Automatic-Repeat-Request Throughput Over Parallel Channels

(75) Inventors: Chuxiang Li, New York, NY (US); Xiaodong Wang, New York, NY (US); Mohammad Madihian, Plainsboro, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/692,978

(22) Filed: Mar. 29, 2007

Related U.S. Application Data
(60) Provisional application No. 60/804,665, filed on Jun. 14, 2006.

(51) Int. Cl. G06F 17/10; H04L 25/60

(52) U.S. Cl. 703/2; 375/214

(57) ABSTRACT

Methods and apparatus for using automatic-repeat-request (ARQ) protocols in multiple parallel channel systems are provided. In parallel channel systems (e.g., MIMO and/or OFDM systems), various ARQ protocols are employed to increase system throughput. Methods of analysis of the throughput of these protocols are also provided to determine an appropriate protocol. These methods include determining the parameters of a packet-layer model from the physical-layer model parameters and the transceiver parameters using Markov modeling techniques. That is, the rate of a state of the ARQ system is determined and the throughput of the ARQ system is then determined based on the rate using a physical-layer Markov model.

This application claims the benefit of U.S. Provisional Patent Application Ser. No. 60/804,665, filed Jun. 14, 2006, which is incorporated herein by reference.

### FIELD OF THE INVENTION

The present invention relates generally to data transmission and more specifically to automatic-repeat-request throughput over parallel correlated fading channels with adaptive rate control.

### BACKGROUND OF THE INVENTION

Automatic-repeat-request (ARQ) is a technique used at the data link layer of the open systems interconnection basic reference model to guarantee reliable data transmission between a transmitter and a receiver. At the receiver, a positive acknowledgement (ACK) or a negative acknowledgement (NACK) (e.g., a message indicating an erroneous packet), is generated for each sent packet. The ACKs and/or NACKs are then sent to the transmitter. At the transmitter, each unreceived and/or damaged packet (e.g., packets which cause NACKs to be generated) will be resent until the transmission succeeds (e.g., indicated when an ACK is generated). The throughput of such a system is the number of packets successfully transmitted and received in a given time. There are three basic ARQ protocols: stop-and-wait (SW), go-back-N (GBN), and selective-repeat (SR). In conventional ARQ, temporal sequential packets are transmitted serially over a single logic channel (e.g., serial ARQ).

Adaptive modulation and coding (AMC) is a technique used at the physical-layer of the open systems interconnection basic reference model to enhance the transmission rate by matching the modulation and coding mode to time-varying channel conditions. It is known to use a combination of AMC in the physical-layer and ARQ in the link-layer to increase the system throughput.

The throughput of parallel ARQ has been analyzed under the assumptions of independent parallel channels and identically independent (i.i.d.) packet fading over each channel. Although the i.i.d. packet fading assumption can be guaranteed by using long interleaving, in practical systems the packets over one link are more likely to be temporally correlated—especially in slow fading environments. Finite-state Markov models have been used to describe the temporally correlated fading of one single physical channel. Additionally, link-layer packet error structures which are related to physical channel fading have been utilized to describe the packet transmission over one single logic channel. In particular, the two-state Gilbert-Elliot model has been applied in data networks where the model parameters have been related to the physical channel fading and the transceivers. The two-state model is extended to a multi-state model associated with AMC and correlated packet fading. It is important to note that the above models only treat serial ARQ.

Prior methods have not determined whether parallel ARQ has any advantages over serial ARQ. Some link-layer results have been reported under the assumptions of identical parallel logic links, i.i.d. packet loss and fixed rate transmission—without practical considerations in the physical-layer.

Prior methods of addressing multichannel communication systems fail to provide adequate analysis of throughput using the various parallel ARQ protocols or provide an appropriate framework for this purpose. Thus, a need exists to improve throughput in ARQ systems. Further, the existing single channel models do not extend to multiple parallel physical channels in orthogonal-frequency-division-multiplexing (OFDM) and multiple-input multiple-output (MIMO) systems and no suitable method exists for calculating the parameters of a packet-layer model from the physical layer model parameters and the transceiver parameters.

### SUMMARY OF THE INVENTION

The present invention provides improved methods and apparatus for analysis of throughput of the various parallel automatic-repeat-request (ARQ) protocols and provides an appropriate framework for this purpose. The present invention also extends single channel models to multiple parallel physical channels in MIMO and OFDM systems and provides a method of determining the parameters of a packet-layer model from the physical layer model parameters and the transceiver parameters.

In a first aspect of the invention, methods of throughput analysis of parallel ARQ over practical systems with multiple parallel physical channels and employing adaptive modulation and coding (AMC) are provided. For throughput analysis, a hierarchical framework for parallel ARQ over practical multichannel systems is provided. In particular, to describe the packet transmission over parallel logic channels, burst-error structure for a single logic channel is extended to multiple parallel logic channels. Based on such a packet-layer model, the throughput of different parallel ARQ protocols is determined. Further, to describe the temporally correlated physical channel fading, existing physical-layer Markov models are extended to multiple parallel physical channels for both MIMO and OFDM systems.

In other aspects, a method of determining packet-layer model parameters from the parameters of the physical-layer model and the transceiver parameters for MIMO and OFDM systems is provided. Using an improved hierarchical throughput analysis framework, throughput gain achieved by parallel ARQ over the conventional serial ARQ in MIMO and OFDM systems is determined.

In still other aspects, a method of operation of a transmitter in a data transmission system is provided. The method includes transmitting a plurality of packets from a transmitter to a receiver over a plurality of parallel channels using to an automatic-repeat-request protocol and receiving from the receiver one of a positive acknowledgment or a negative acknowledgement for each of the plurality of packets.

### BRIEF DESCRIPTION OF THE FIGURES

FIG. 1 depicts multichannel transmission system according to some embodiments of the present invention.

FIG. 2 depicts a frame structure 200 according to some embodiments of the invention.

FIGS. 3A and 3B depict a parallel ARQ protocol according to some embodiments of the present invention.

FIGS. 4A and 4B depict a parallel ARQ protocol according to some embodiments of the present invention.

FIGS. 5A and 5B depict a parallel ARQ protocol according to some embodiments of the present invention.

FIG. 6A illustrates different transmission modes as examples for uncoded AMC.

FIG. 6B illustrates different transmission modes as examples for convolutionally coded AMC.

FIG. 7 illustrates a model for parallel ARQ transmission according to some embodiments of the present invention.

FIG. 8 illustrates a method of throughput analysis in parallel channel automatic-repeat-request systems.

FIG. 9A depicts an N-state physical-layer Markov model for a single correlated fading channel.

FIG. 9B depicts an extended physical-layer Markov model for generalized parallel channels.

### DETAILED DESCRIPTION

The present invention generally provides methods and apparatus for determining models for parallel automatic-repeat-request (ARQ) in systems with multiple parallel channels. More specifically, the present invention provides a method of analyzing throughput of multiple ARQ protocols based on the generalized model of packet-layer error structure for multiple parallel logic channels. The present invention further provides methods for determining the packet-layer model parameters from the parameters of the extended physical-layer model for parallel physical channels and the parameters of MIMO and OFDM systems.

Various types of communication systems have multiple parallel physical channels. For instance, multiple parallel physical channels are provided in frequency and spatial domains by orthogonal-frequency-division-multiplexing (OFDM) and multiple-input multiple-output (MIMO) systems, respectively. Such multichannel communication systems have several advantages including increased reliability, simple synchronization and equalization, low complexity in detection and decoding, etc. The application of ARQ is combined with adaptive modulation and coding (AMC) over the communication systems with multiple parallel physical channels. One approach is to translate the multiple physical channels into a single logic channel, over which serial ARQ protocols combined with AMC can be applied.

Another method is to translate each physical channel into a separate logic channel (e.g., multiple logic channels are simultaneously available in the system), allowing multiple parallel ARQ links to exist simultaneously. Such an ARQ scheme is called parallel ARQ. In data networks or cooperative diversity systems, multiple routes (e.g., multiple logic channels) are provided for each source and destination node pair. Thus, the corresponding ARQ can also refer to the generalized parallel ARQ mentioned above.

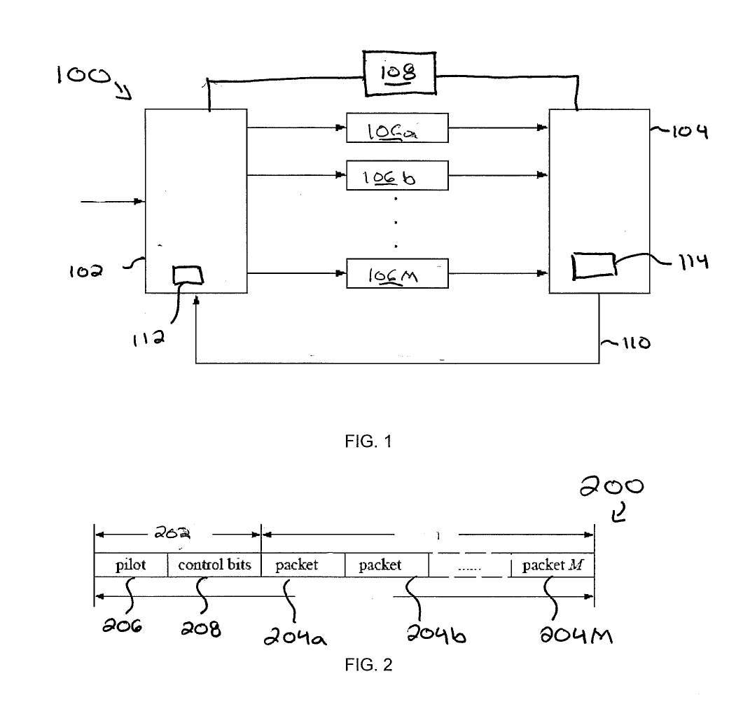

FIG. 1 depicts multichannel transmission system 100 according to an embodiment of the present invention. The system 100 comprises a transmitter 102 and a receiver 104. Transmitter 102 may be adapted to transmit signals (e.g., wireless communication signals, frames, etc.) over a plurality of channels (e.g., parallel logic channels, data channels, etc.) 106a-M. Receiver 104 may be adapted to receive and/or process signals received from the transmitter 102 via the channels 106a-M. The system 100 may also have a controller 108 which may be in communication with transmitter 102 and/or receiver 104. Transmission system 100 may also have one or more backward (e.g., feedback) channels 110 adapted to transfer information (e.g., an ACK, a NACK, a retransmission request, etc.) transmitted from the receiver 104 to the transmitter 102 and/or the controller 108. Transmitter 102 may include one or more buffers 112; similarly, receiver 104 may include one or more buffers 114.

Transmitter 102, receiver 104, and buffers 112 and 114 are well known in the art. One skilled in the art would recognize that system 100 would have other components as well. It is understood that any appropriate combination of these components may be used to implement the invention as described herein. For example, the method steps of method 800 may be employed on, by, or at any combination of the controller 108, transmitter 102, the receiver 104, and/or any other device in the system 100.

In some embodiments, controller 108 may be or may include any components or devices which are typically used by, or used in connection with, a computer or computer system. Although not explicitly pictured in FIG. 1, the controller 108 may include one or more central processing units, read only memory (ROM) devices and/or a random access memory (RAM) devices. The controller 108 may also include input devices such as a keyboard and/or a mouse or other pointing device, and output devices such as a printer or other device via which data and/or information may be obtained, and/or a display device such as a monitor for displaying information to a user or operator. The controller 108 may also include a transmitter and/or a receiver such as a LAN adapter or communications port for facilitating communication with other system components and/or in a network environment, one or more databases for storing any appropriate data and/or information, one or more programs or sets of instructions for executing methods of the present invention, and/or any other computer components or systems, including any peripheral devices.

According to some embodiments of the present invention, instructions of a program (e.g., controller software) may be read into a memory of the controller 108 from another medium, such as from a ROM device to a RAM device or from a LAN adapter to a RAM device. Execution of sequences of the instructions in the program may cause the controller 108 to perform one or more of the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory may store the software for the controller which may be adapted to execute the software program, and thereby operate in accordance with the present invention, and particularly in accordance with the methods described in detail below. However, it would be understood by one of ordinary skill in the art that the invention as described herein can be implemented in many different ways using a wide range of programming techniques as well as general purpose hardware sub-systems or dedicated controllers.

The program may be stored in a compressed, uncompiled and/or encrypted format. The program furthermore may include program elements that may be generally useful, such as an operating system, a database management system and device drivers for allowing the controller to interface with computer peripheral devices and other equipment/components. Appropriate general purpose program elements are known to those skilled in the art, and need not be described in detail herein.

As indicated herein, the controller 108 may generate, receive, store and/or use for computation databases including data related to transmission, scrambling, beamforming, and/or preceding. As will be understood by those skilled in the art, the schematic illustrations and accompanying descriptions of the structures and relationships presented herein are merely exemplary arrangements. Any number of other arrangements may be employed besides those suggested by the illustrations provided.

FIG. 2 depicts a frame structure 200 according to an embodiment of the invention. Frame structure 200 comprises a frame head 202 and/or a plurality of packets (e.g., data packets) 204a-M. Frame head 202 comprises a pilot 206 and/or control information (e.g., control bits) 208.

In operation, transmitter 102 transmits one or more frame structures 200 over one or more of channels 106a-M to receiver 104. In an advantageous embodiment, the packets 204a-M corresponding to a single frame structure 200 are transmitted simultaneously over one or more channels 106a-M. Each of channels 106a-M may be provided with a corresponding cyclic redundancy check (CRC) and/or channel codec such that an ACK and/or a NACK may be generated for each packet 204a-M separately. Frame structures 200 and/or packets 204a-M may be transmitted according to any appropriate ARQ protocol over system 100, as will be discussed in detail below.

In some embodiments (e.g., during modeling of the system 100), perfect channel state information (CSI) may be assumed to be available at transmitter 102. Further, throughput analysis may only analyze the data packets 204a-M without the head 202. Still further, the backward channel 110 for ACK and/or NACK delivery may be assumed to be error free.

FIGS. 3A-5B depict parallel ARQ protocols according to some embodiments of the present invention. The protocols are described herein with reference to the transmission system 100 and frame structure 200 described above though any appropriate transmission system and/or frame structure may be utilized. Each of the parallel ARQ protocols has two different implementation schemes, namely, type-I and type-II. In type-I schemes channels 106a-M share the same queues (not shown) and/or ARQ buffers 112 and/114. In type-II schemes each channel 106a-M has its own independent queue (not shown) and ARQ buffer 112 and/or 114 (e.g., the packets 204a-M to be resent will occupy the same logic channel 106a-M with which their preceding versions were transmitted). Systems employing parallel type-II ARQ are the superposition of M independent serial ARQ channels. Herein, it is assumed that in type-I schemes the packet transmissions over different parallel logic channels are synchronous and in type-II schemes the packet transmissions over different logic channels are not necessarily synchronous and the maximum number of retransmissions is infinite.

FIGS. 3A and 3B depict a parallel ARQ protocol according to some embodiments of the present invention. In the parallel stop-and-wait (SW) protocol of FIGS. 3A and 3B, the transmitter 102 transmits a frame 200 of M packets 204a-M at a frame duration to the receiver 104. The transmitter 102 then suspends transmission to wait for an ACK and/or NACK from the receiver 104. The round-trip delay may be defined as D=T_{D}/T_{P} where T_{D} and T_{P} are the round-trip waiting time and packet transmit time, respectively. After 1+D packet durations, once ACKs are received for all M packets 204a-M, the transmitter 102 will then send a new frame 200. In the parallel SW protocol of FIG. 3A, if a NACK is received for any packet 204a-M (e.g., packet m), in parallel SW type-I protocol (parallel SW-I), the transmitter 102 will then resend the packet m and all the following packets within that frame (m+1, m+2, . . . , M). In the parallel SW protocol of FIG. 3B, in parallel SW type-II protocol (parallel SW-II), the transmitter 102 will only resend the packet m over the corresponding channel m while continuing the new transmission over all the other channels 106a-M.

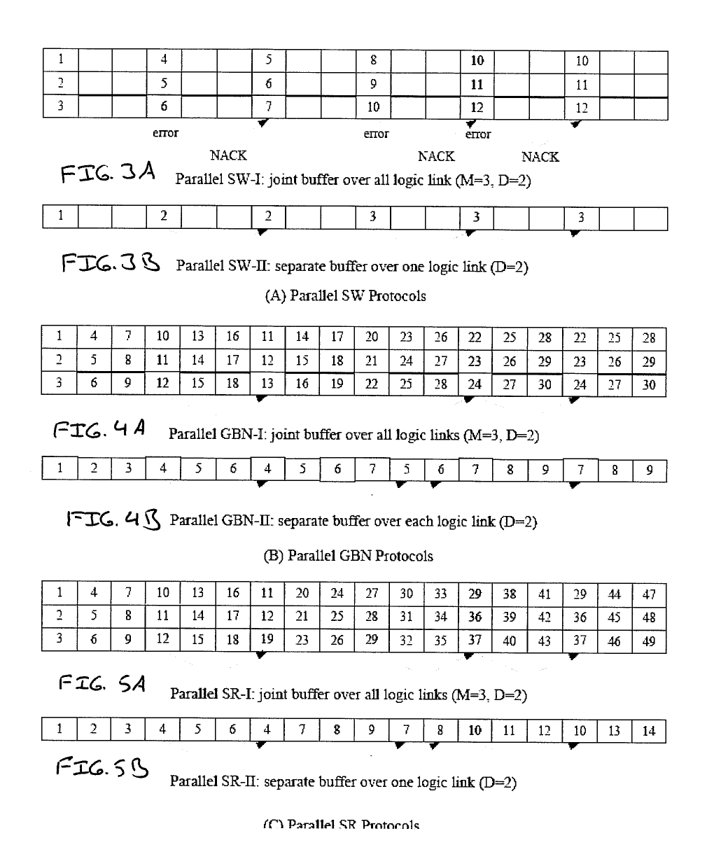

FIGS. 4A and 4B depict a parallel ARQ protocol according to some embodiments of the present invention. In the parallel go-back-n (GBN) protocol of FIGS. 4A and 4B, the transmitter 102 sends the frames 200 successively to the receiver 104 without waiting for an ACK and/or NACK which is transmitted from the receiver 104 to the transmitter 102 after a round-trip delay of D frames 200 (e.g., M×(D+1) packets are transmitted). In parallel GBN-I depicted in FIG. 4A, once a NACK for packet m in one frame 200 is received, the transmitter 102 resends the packets m, m+1, . . . , M in that frame 200 as well as all of the M×D packets 204a-M in the following D frames. In contrast, in parallel GBN-II depicted in FIG. 4B, only the D+1 packets transmitted over channel m will be resent via channel m. For parallel GBN, buffer 112 is only required at the transmitter 102.

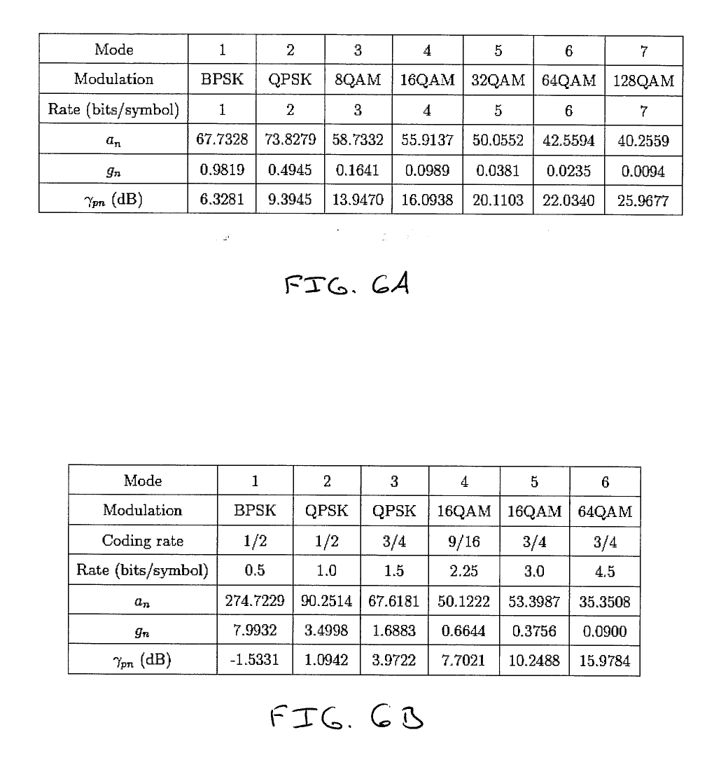

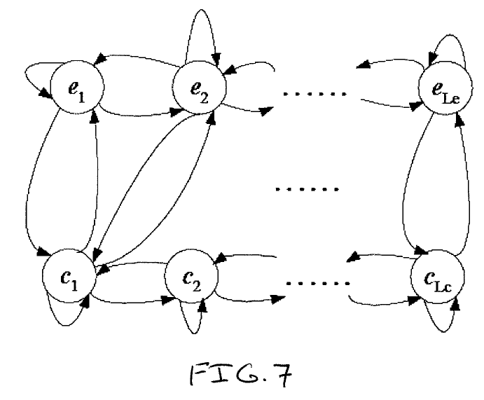

FIGS. 5A and 5B depict a parallel ARQ protocol according to some embodiments of the present invention. In the parallel selective-repeat (SR) protocol of FIGS. 5A and 5B, the transmitter 102 sends the frames 200 successively without waiting for an ACK and/or NACK. Once a NACK is received for a packet m, in parallel SR-I depicted in FIG. 5A, only the packet m is resent over the next available channel 106a-M (in order). That is, the resent packet m may not necessarily be retransmitted on channel m, but will be transmitted over the next available channel 106a-M. In parallel SR-II depicted in FIG. 5B, the packet m will be resent over the logic channel m itself. For parallel SR, buffers 112 and 114 are required at both the transmitter 102 and receiver 104.

AMC may be employed in the system 100 as shown in FIG. 1. That is, different transmission rates may be selected for different packets according to their CSI. In particular, each packet 204a-M may be transmitted using L possible transmission modes with the rates R ε {R₁, R₂, . . . , R_{L}}. For systems without forward-error-correction (FEC) code (e.g., uncoded systems), each AMC mode may correspond to one modulation type (e.g., BPSK, QPSK, and 8QAM, etc.). For coded systems employing FEC codes, each AMC mode may correspond to one combination of the modulation and coding scheme. FIGS. 6A and 6B show different transmission modes as examples for uncoded AMC and convolutionally coded AMC, respectively.

The parameters aₙ, gₙ and γₚₙ in FIGS. 6A and 6B are used for packet-error-ratio (PER) approximation. PER depends on specific modulation, coding, and SNR, and it is, in general, not analytical available. Thus, curve fitting may be employed to use some mathematical form to approximate PER curve, which may be obtained via numerical simulations. The three parameters above are the parameters in the mathematical form used for curve fitting. Specifically, the PER of AMC mode n can be approximated by:

$${P}_{n}^{F} ( γ ) \approx \{ \begin{matrix} 1 , & if 0 < γ < {γ}_{pn} , \\ {a}_{n} exp ( - {g}_{n} γ ) & if γ \geq {γ}_{pn} ,\end{matrix} n = 1 , 2 , … , L ,$$

where γ denotes the received signal-to-noise ratio (SNR).

FIG. 7 illustrates a model 700 for parallel ARQ transmission according to some embodiments of the present invention. Specifically, model 700 is a packet-layer Markov model for the parallel ARQ transmission over M logic channels with L possible AMC modes for each logic channel wherein Lₑ=(L+1)M−L_{M} and L_{C}=L_{M}.

ARQ transmission over one single dynamic logic channel may be described by an (L+1)-state Markov model which includes one error state and L correct states. In particular, each of the L correct states corresponds to the case in which the transmission is successfully completed with one of the L possible transmission modes. The error state indicates the case in which the transmission fails with all possible L transmission modes. Similarly, packet-layer parallel ARQ transmission over M parallel dynamic logic channels may be described by an extended model of packet error structure.

Specifically, one packet-layer state is denoted as s=[s₁, s₂, . . . , s_{M}], where sₘ indicates the case of logic channel m, where 1≦m≦M,

$${s}_{m} = \{ \begin{matrix}0 , & error transmission over logic channel m , \\ l , & \begin{matrix}successful transmission over logic channel \\ m with l \text{-} th mode ,\end{matrix}\end{matrix}$$

where l ε {1, 2, . . . , L}, and the packet-layer state s can be further denoted as

$$s \text{:} ( \begin{matrix}an error state ( e ) , & ∃ m , such that {s}_{m} = 0 , \\ a correct state ( c ) , & {s}_{m} > 0 , ∀ m ,\end{matrix} 1 \leq m \leq M .$$

### Given L possible transmission modes for each logic channel m, there are, in total, (L+1)M packet-layer states, {s₁, s₂, . . . , s_{(L+1)}^{M}}, within which there exists Lₑ=(L+1)^{M}−L^{M} error states, denoted as {eᵢ, 1≦i≦Lₑ}, and L_{C}=L^{M} correct states, denoted as {cⱼ, 1≦j≦Lₑ}.

To characterize the packet-layer model 700, the steady-state probability π and the state transition probability P are required. In particular,

$$\begin{matrix}P = [ \begin{matrix}{Pe}_{1} , {e}_{1} & {Pe}_{1} , {e}_{2} & ⋯ & {Pe}_{1} , {e}_{{L}_{e}} & {Pe}_{1} , {c}_{1} & ⋯ & {Pe}_{1} , {c}_{{L}_{c}} \\ {Pe}_{2} {e}_{1} & {Pe}_{2} , {e}_{2} & ⋯ & {Pe}_{2} , {e}_{{2}_{e}} & {Pe}_{2} , {c}_{1} & ⋯ & {Pe}_{2} , {c}_{{L}_{c}} \\ ⋮ & ⋮ & ⋰ & ⋮ & ⋯ & ⋰ & ⋮ \\ {Pe}_{{L}_{e}} , {e}_{1} & {Pe}_{{L}_{e}} , {e}_{2} & ⋯ & {Pe}_{{L}_{e}} , {e}_{{L}_{e}} & {Pe}_{{L}_{e}} , {c}_{1} & ⋯ & {Pe}_{{L}_{e}} , {c}_{{L}_{c}} \\ {Pc}_{1} , {e}_{1} & {Pc}_{1} , {e}_{2} & ⋯ & {Pc}_{1} , {e}_{{L}_{e}} & {Pc}_{1} , {c}_{1} & ⋯ & {Pc}_{1} , {c}_{{L}_{c}} \\ {Pc}_{2} , {e}_{1} & {Pc}_{2} , {e}_{2} & ⋯ & {Pc}_{2} , {e}_{{L}_{e}} & {Pc}_{2} {c}_{1} & ⋯ & {Pc}_{2} , {c}_{{L}_{c}} \\ ⋮ & ⋮ & ⋰ & ⋮ & ⋰ & & ⋮ \\ {Pc}_{{L}_{c}} , {e}_{1} & {Pc}_{{L}_{c}} , {e}_{2} & ⋯ & {Pc}_{{L}_{c}} , {e}_{{L}_{e}} & {Pc}_{{L}_{c}} , {c}_{1} & ⋯ & {Pc}_{{L}_{c}} , {c}_{{L}_{c}}\end{matrix} ] \\ = [ \begin{matrix}{Pe}_{1} \\ {Pe}_{2} \\ ⋮ \\ {Pe}_{L} \\ {Pc}_{1} \\ {Pc}_{2} \\ ⋮ \\ {Pc}_{{L}_{c}}\end{matrix} ]\end{matrix}$$

where the (i,j) entry (Pₛᵢ,sⱼ) denotes the one-step state transition probability from sᵢ to sⱼ, sᵢ, sⱼ ε {e₁, . . . , e_{Le}, c₁, . . . , c_{Lc}}, 1≦i, j≦Lₑ+L_{c}. The steady-state probability vector for the packet-layer model may be defined as π=[πₛ₁, πₛ₂, . . . , π_{sLe+Lc}], where πₛ₁ denotes the steady-state probability of s₁, 1≦l≦Lₑ+L_{c}. Given

Σ^{L}^{ₑ}^{+L}^{_{c}}ₗ₌₁P_{S}_{ₖ}_{,S}_{ₗ}=1 and Σ^{L}^{ₑ}^{+L}^{_{c}}ₗ₌₁π_{S}_{ₗ}P_{S}_{ₖ}_{,S}_{ₗ}=Σ^{L}^{ₑ}^{+L}^{_{c}}ₗ₌₁π_{S}_{ₖ}P_{S}_{ₖ}_{,S}_{ⱼ}, ∀k ε {1, 2, . . . , Lₑ+L_{c}},

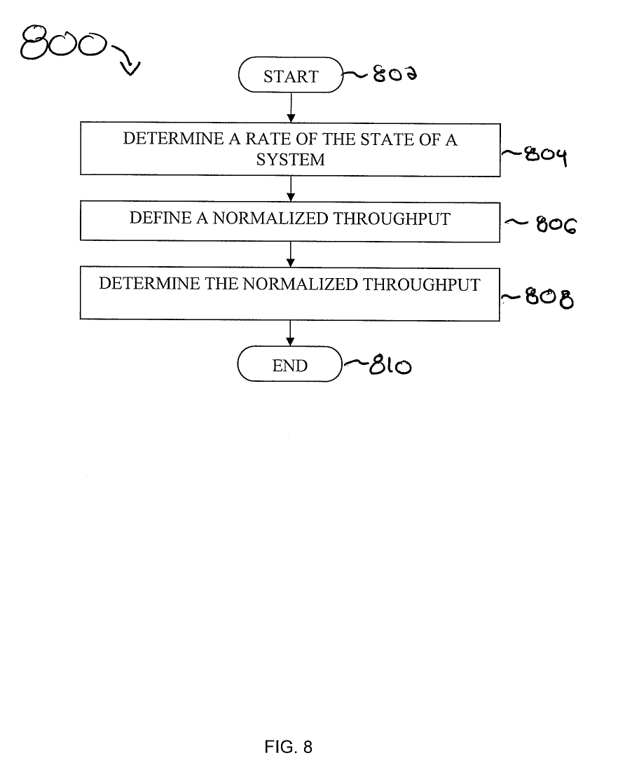

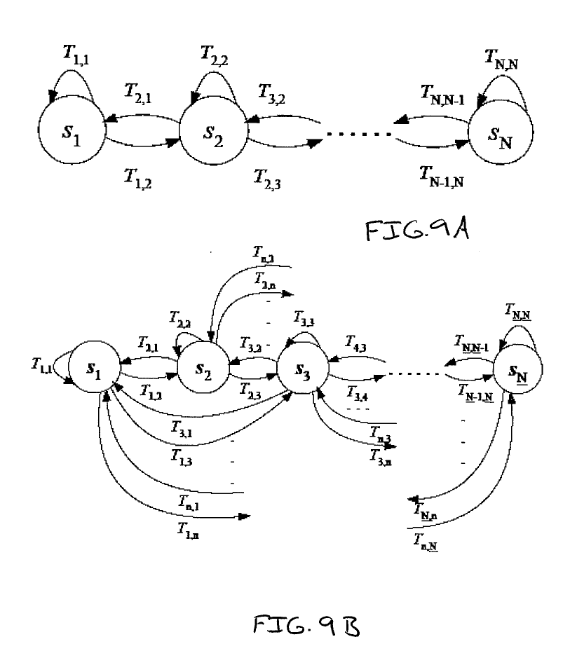

the steady-state probability π can be calculated using the following constraints:

$$\{ \begin{matrix}π \cdot P = π , \\ π \cdot 1 = {\sum }_{i = 1}^{{L}_{e} + {L}_{c}} {π}_{{s}_{i}} = 1 ,\end{matrix}$$

where 1=[1, 1, . . . , 1]^{T}. In some embodiments, both P and π depend on the specific physical channels and transceiver employed by the system. In the method discussed below with respect to FIG. 8, P and π are assumed to be known. Further discussion will specify how to calculate P and π in different application scenarios.

FIG. 8 illustrates a method 800 of throughput analysis in parallel channel automatic-repeat-request systems. The method begins at step 802.

In step 804, a rate of the state is determined. In parallel SW and parallel GBN systems, the rate Q may be defined as:
Q=diag{q^{Q1}, q^{Q2}, . . . , q^{QLe+Lc}} where Q₁ is the total rate of s₁, and

$$Q = {\sum }_{m = 1}^{{m}_{0}^{( l )} - 1} {R}_{sl , m} , \\ 1 \leq l \leq {L}_{e} + {L}_{c} ,$$

where m⁽¹⁾₀ is the index of the first zero entry in s₁=[s_{1,1}, s_{1,2}, . . . , s_{1,M}]:

$${m}_{0}^{( l )} = \{ \begin{matrix}{min}_{m} \{ m : m ∈ {θ}_{{S}_{l}} \} , & if {θ}_{{S}_{l}} {=}^{Δ} \\ M + 1 , & if {θ}_{s} , = φ .\end{matrix} \{ m \text{\textbar} {s}_{l , m} = 0 , 1 \leq m \leq M \} \neq φ ,$$

For instance, m⁽ⁱ⁾₀=M+1 for any correct state cᵢ and 1≦m^{(j)}₀≦M for any error state eⱼ; Q₁=R₁+R₂ for s₁=[1, 2, 0, 1, . . . , 0] and Q₁=0 for s₁=[0, 3, 1, . . . , 2]. In the state transition probability matrix P, the error states e₁˜e_{Le} may be ordered in the following manner—for two error states eᵢ and eⱼ, the indexes

$$\{ \begin{matrix}i = 1 & if {e}_{i , 1} = {e}_{i , 2} = … = {e}_{i , M} = 0 , \\ 1 = < j < 1 \leq {L}_{e} & if {m}_{0}^{( i )} > 1 and {m}_{0}^{( j )} = 1 ,\end{matrix}$$

(e.g., the error states which have a first entry as zero have lower state indexes). For instance, for M=2 and L=2, there are (L+1)^{M}=9 total states including Lₑ=5 error states which can be ordered as e₁=[0, 0], e₂=[0, 1], e₃=[0, 2], e₄=[1, 0], e₅=[2, 0]. It should be noted that the relative ordering of e₂˜e₃ can be exchanged, and so may those of e₄˜e₅.

In the particular example of parallel SW ARQ, the round-trip delay or the “idle time” measured in the number of frame durations is D=2. Without loss of generality, the first frame duration within each D+1 frames is designated as the transmission time, denoted by “cᵢ” or “eⱼ”, ∀i, j, and the remaining D frame durations as “idle” time, denoted by “0”. The long sequence may be divided into several cycles, each of which starts at an erroneous transmission duration and is ended before another erroneous transmission duration which is closest to the starting frame. In other words, within one cycle, only the transmission in the starting frame duration is in error, and all the other transmissions are correct.

In parallel SR ARQ systems, the rate Q may be defined as \tilde{Q}=diag{q^{\tilde{Q}}^{₁}, q^{\tilde{Q}}^{₂}, . . . , q^{\tilde{Q}}^{_{L1}}_{—}^{_{L2}}} where \tilde{Q}₁ is the total rate of s₁ in parallel SR and

$${\tilde{Q}}_{l} = {\sum }_{m = 1}^{M} {R}_{{s}_{l , m}} , 1 \leq l \leq {L}_{e} + {L}_{c} .$$

The rate here differs from Q₁ defined in above for SW ARQ, as the SR ARQ rate takes in account the rates of all M parallel channels instead of only considering those before the first parallel channel in error. This arises from the inherent mechanism of the parallel SR protocol. In particular, when the packet transmitted via channel m is in error, the packets transmitted over all the subsequent parallel channels have to be resent in parallel SW or GBN. In contrast, only the packet m needs to be retransmitted in parallel SR.

In step 806, the normalized throughput is defined. In parallel SW ARQ, the normalized throughput may be defined as the average effective rate per frame duration. Specifically, the rate of the correctly received packets in one cycle divided by the overall number of frame durations within one cycle or

$$η sw = \frac{{\overline{R}}_{SW}}{( D + 1 ) {\overline{N}}_{SW}}$$

where R̅_{SW} denotes the average rate corresponding to the correctly received packets in one single cycle, and N̅_{SW} denotes the average number of transmissions occurred in one cycle.

The average number of transmissions within one cycle can be expressed by

$${\overline{N}}_{SW} = {\sum }_{k = 1}^{∞} k \underbrace{{P}_{r} \{ \begin{matrix}start at an error state and go \\ to an error state after k ( D + 1 ) frames\end{matrix} \}}_{{P}_{r} \{ {N}_{SW} = k \}} .$$

In matrix form, this may be expressed as:

$$\begin{matrix}{\overline{N}}_{SW} = απ Pe ( D + 1 ) 1 + {α}_{π} {\sum }_{k = 2}^{∞} k π [ \begin{matrix}Pe , c ( D + 1 ) {( Pc ( D + 1 ) )}^{k - 2} \\ Pc , e ( D + 1 )\end{matrix} ] \\ = {α}_{π} π [ \begin{matrix}Pe ( D + 1 ) + {\sum }_{k = 2}^{∞} kPe , c ( D + 1 ) \\ {( Pc ( D + 1 ) )}^{k - 2} Pc , e ( D + 1 )\end{matrix} ] 1.\end{matrix} 1$$

Accordingly, the average effective rate may be expressed as:

$$\begin{matrix}{\overline{R}}_{SW} = \frac{\partial }{\partial q} ( {α}_{π} π [ \begin{matrix}Φ e ( D + 1 ) + {\sum }_{k = 2}^{∞} Φ e , c ( D + 1 ) \\ {( Φ c ( D + 1 ) )}^{k - 2} Φ c , e ( D + 1 )\end{matrix} ] 1 ) {\vert}_{q = 1} where Φ e ( l ) \\ = Pe ( l ) Q , Φ e , c ( l ) \\ = Pe , c ( l ) Q , Φ c ( l ) \\ = Pc ( l ) Q , and Φ c , e ( l ) \\ = Pc , e ( l ) Q , .\end{matrix}$$

$$l = 1 , 2 , …$$

In parallel GBN ARQ, the throughput may also be defined as the effective rate per frame. Specifically,

$${η}_{GBN} = \frac{{\overline{R}}_{GBN}}{1 + D + {\overline{N}}_{GBN}} ,$$

where R̅_{GBN} and N̅_{GBN} denote the average effective rate and the average number of transmitted frames within one single cycle, respectively. The cycle here is the same cycle as in parallel SW in the sense that both cycles are defined as being between two consecutive erroneous transmission frame durations while there exists no idle time within the cycle. This arises from the property of parallel GBN protocols.

The average number of transmitted frames in one single cycle, N̅_{GBN}, can be written as:

$$\begin{matrix}{\overline{N}}_{GBN} = {α}_{π} {\sum }_{m = 1}^{{L}_{e}} π {e}_{m} {\sum }_{l = 1}^{{L}_{e}} {Pe}_{m , {c}_{l}} ( D ) {\sum }_{k = 1}^{∞} {kP}_{r} \\ \{ starts at {c}_{l} and goes to error after k frames \} \\ = {α}_{π} {\sum }_{m = 1}^{{L}_{e}} π {e}_{m} {\sum }_{l = 1}^{{L}_{e}} {Pe}_{m , {c}_{l}} ( D ) \underbrace{{\sum }_{k = 1}^{∞} k {\sum }_{j = 1}^{{L}_{e}} \overline{P} {c}_{l} , {e}_{j} ( k )}_{{N}_{GBN} ( m , l )} \\ = {\sum }_{k = 1}^{∞} k {α}_{π} \underbrace{{\sum }_{m = 1}^{{L}_{e}} π {e}_{m} {\sum }_{i = 1}^{{L}_{c}} {Pe}_{m , {c}_{l}} ( d ) {\sum }_{j = 1}^{{L}_{e}} \overline{P} {c}_{l} {e}_{j} ( k )}_{{P}_{r} \{ {N}_{GBN} = k \}} \\ = {απ}_{π} [ {\sum }_{k = 1}^{∞} kPe , c ( D ) \overline{P} c , e ( k ) ] 1 ,\end{matrix}$$

where Pₑₘ,c₁(D) denotes the (m,L₁+1) entry of P(D), P̅_{c1,ej}(k) is the (Lₑ+1, j) entry of P̅(k)= P̅^{k} with P̅^{T}=[0, . . . , 0, p^{T}_{c1}, p^{T}_{c2}, . . . , p^{T}_{cLc}]^{T}=[P_{c,e}+P_{c}]^{T}, and P̅_{c,e}(k) is defined for P̅(k) just as P_{e,c}(k) is defined for P(k) above. Thus, the average effective rate R̅_{GBN} may be written as:

$${\overline{R}}_{GBN} = {α}_{π} {\sum }_{m = 1}^{{L}_{e}} π {e}_{m} \frac{\partial }{\partial q} [ \underbrace{{\sum }_{m = 1}^{{L}_{e}} {Pe}_{m} , {e}_{l} ( D ) {q}^{{Q}_{l}}}_{R ( m , k = 0 )} + {\sum }_{l = 1}^{{L}_{c}} {Pe}_{m} , {c}_{l} ( D ) \underbrace{{\sum }_{k - 1}^{∞} {q}^{{QL}_{e + 1}} {\sum }_{j = 1}^{{L}_{e}} ψ {L}_{e + l , j ( k )}}_{R ( m , l , k \geq 1 )} ] {\vert}_{q = 1} \frac{\partial }{{\partial }_{q}} ( {α}_{π} π [ \underbrace{Pe ( D ) Q}_{Φ e ( d )} + {\sum }_{k = 1}^{∞} \underbrace{Pe , c ( D ) Q Ψ c , e ( k )}_{Φ e , c ( D )} ] 1 ) {\vert}_{q = 1}$$

where ψ_{Le+1,j}(k) is the (Lₑ+1, j) entry of the matrix ψ(k)=ψ^{k} with ψ= P̅Q=P_{c,e}Q+P_{c}Q, ψ_{c,e}(k) is defined for ψ(k) just as P_{e,c}(k) is defined for P(k) above. Note that N_{GBN}(m, 1) denotes the average number of transmitted frames for the case of starting from the D-step transition eₘ→c₁ and finally ending by the k-step transition c₁→eⱼ, ∀j, during which only correct states are involved; R(m, l, k≧1) denotes the corresponding effective rate for the above case and R(m, k=0) denotes the effective rate for the D-step transition eₘ→e₁, ∀1.

In parallel SR ARQ, the throughput may be defined as the effective rate per frame:

$${η}_{SR} = {lim}_{k \to ∞} \frac{\frac{\partial }{\partial q} ( πΩ ( k ) 1 ) \text{\textbar} q = 1}{k} = {\sum }_{j = 1}^{{L}_{e} + {L}_{c}} {\overline{Q}}_{j} , π {s}_{j} .$$

In step 808, the normalized throughput is determined. For SW ARQ, the normalized throughput η_{SW}^{P}^{₁} for parallel SW-I ARQ can thus be determined (e.g., calculated) using the equations of step 806. For parallel SW-II ARQ, since it is equivalent to the superposition of M of serial SW ARQ link, the corresponding throughput is then given by:

$${η}_{SW}^{{P}_{2}} = {\sum }_{m = 1}^{M} \frac{{\overline{R}}_{SW} ( m )}{( 1 + D ) {\overline{N}}_{SW} ( m )} = {\sum }_{m = 1}^{M} {η}_{SW}^{S} ( m ) ,$$

where R̅_{SW} (m) and N̅_{SW} (m) denote the average effective rate and the average number of transmission within one cycle over the single logic channel m, respectively and η_{SW}^{S} (m) is the average throughput of logic channel m. Note that N̅_{SW} (m) and R̅_{SW} (m) may also be calculated using step 806, where the state transition probability matrix P here corresponds to the single logic link m with L+1 states and thus is a reduced version of P with a dimension of (L+1)×(L+1).

Similarly, the normalized throughput η_{GBN}^{P}^{₁} for parallel GBN-I ARQ can thus be determined (e.g., calculated) as shown in step 806. For parallel GBN-II ARQ, similarly as parallel SW-II above, the normalized throughput η_{GBN}^{P}^{₂} is given by:

$${η}_{GBN}^{{P}_{2}} = {\sum }_{m = 1}^{M} \frac{{\overline{R}}_{GBN} ( m )}{1 + D + {\overline{N}}_{GBN} ( m )} = {\sum }_{m = 1}^{M} {η}_{GBN}^{S} ( m ) ,$$

where R̅_{GBN} (m) and N̅_{GBN} (m) denote the average effective rate and the average number of transmission within one cycle over the single logic channel m, respectively and η_{GBN}^{S} (m) is the average throughput of logic channel m. Note that N̅_{GBN} (m) and R̅_{GBN} (m) can also be calculated as in step 806 employing the reduced version of P above.

For SR ARQ, the throughput may be determined (e.g., calculated) as such:

$$\begin{matrix}{η}_{SR} = \frac{\partial }{\partial q} ( {ψ}_{1} 1 ) {\vert}_{q = 1} & = {R}_{2} {P}_{1} ( 1 - {P}_{2} ) + {R}_{1} ( 1 - {P}_{1} ) {P}_{2} + ( {R}_{1} + {R}_{2} ) ( 1 - {P}_{1} ) ( 1 - {P}_{2} ) \\ = {\sum }_{j = 1}^{{L}_{e} + {L}_{c}} {\overline{Q}}_{j} , π {s}_{j} & = {R}_{1} ( 1 - {P}_{1} ) + {R}_{2} ( 1 - {P}_{2} ) + {\sum }_{m = 1}^{M} {R}_{m} ( 1 - {P}_{m} ) .\end{matrix}$$

The method ends at step 812.

FIGS. 9A and 9B illustrate physical-layer Markov models for use in some aspects of the present invention. Specifically, FIG. 9A depicts an N-state physical-layer Markov model for a single correlated fading channel and FIG. 9B depicts an extended physical-layer Markov model for generalized M₀ parallel channels with N=N_{γ}=N^{M0} physical-layer states.

In some embodiments, the state transition probability matrix P, which depends on both the physical channel fading property and the specific transceiver employed is assumed available. In alternative embodiments, different time-varying physical channel fading and their corresponding transceivers may be utilized to determine P.

In particular, physical-layer Markov modeling for a single channel may be employed. γₘ is the instantaneous received SNR over a time-correlated fading channel. The time-varying behavior of γₘ(t) can be described by a finite-state Markov model as shown in FIG. 9A. A set of physical-layer states may be designated {s₁^{γm}, s₂^{γm}, . . . , s_{N}^{γm}} and Γ={Γ₁, Γ₂, . . . , Γ_{N+1}} is a set of SNR thresholds with 0=Γ₁<Γ₂< . . . <Γ_{N}<Γ_{N+1}=∞. The channel falls in the state sₙ^{γm} when Γₙ≦γₘ(iT_{F})<Γₙ₊₁, ∀n ε {1, 2, . . . , N}, where T_{F} is the frame duration and γₘ(iT_{F}) is the SNR sample at time t=iT_{F}.

The steady-state probability of this model, π_{γ}_{ₘ}=[π₁^{γ}^{ₘ}, π₂⁶⁵ ^{ₘ}, . . . , π_{N}^{γ}^{ₘ}], is given by

πₙ^{γ}^{ₘ}=Pᵣ{Γₙ≦γₘ<Γₙ₋₁}=∫_{Γ}_{ₙ}^{Γ}^{ₙ₊₁}f₆₅ _{ₘ}(γ)dγ, n=1, 2, . . . , N,

where f₆₅ _{ₘ}(.) is the probability density function (pdf) of γₘ. With the assumption that transition only occurs between the adjacent states, the state transition probability matrix of this model, T_{γ}_{ₘ}=└T_{n,k}^{γ}^{ₘ}┘_{n,k}, may be approximated by:

$${T}_{n , k}^{{γ}_{m}} = {P}_{r} \{ {s}_{k}^{{γ}_{m}} at t + 1 \text{\textbar} {s}_{n}^{{γ}_{m}} at t \} \text{:} \{ \begin{matrix}{T}_{n , n + 1}^{{γ}_{m}} \approx \frac{N ( {Γ}_{n + 1} ) {T}_{F}}{{π}_{n}^{{γ}_{m}}} , n = 1 , 2 , … , N - 1 , \\ {T}_{n , n - 1}^{{γ}_{m}} \approx \frac{N ( {Γ}_{n} ) {T}_{F}}{{π}_{n}^{{γ}_{m}}} , n = 2 , 3 , … , N , \\ {T}_{n , k}^{{γ}_{m}} = , 0 \vert n - k \vert \geq 2 , \\ {T}_{n , n + 1}^{{γ}_{m}} = {\sum }_{i = 1 , l \neq n}^{N} {T}_{n , l}^{{γ}_{m}} , n = 1 , 2 , … , N .\end{matrix}$$

where N(Γ) is the level crossing rate (LCR) of the random process γₘ(t) crossing a given threshold Γ in the positive (or negative) direction, and N(Γ) is in general defined by N_{γ}_{ₘ}(Γ)=∫\dot{γ}ₘf(\dot{γ}ₘ,Γ)d\dot{γ}ₘ, where

$${γ}_{m}^{*} = \frac{d {γ}_{m} ( t )}{d t}$$

and f(\dot{γ}ₘ, Γ) is the joint pdf of \dot{γ}ₘ at γₘ=Γ. For Rayleigh fading channels, γₘ is exponentially distributed, and thus the preceding equations have closed-form solutions. However, f₆₅ _{ₘ}(γ) may not always be available, and thus, π_{γ}_{ₘ} and T_{γ}_{ₘ} may be obtained numerically.

To set up the Markov model in FIG. 9A, the SNR region boundary set Γ is determined. For example, the criterion based on PER constraints may be used to find Γ as follows. Each physical-layer state corresponds to one AMC mode n. That is, AMC mode n is selected when γₘε[γₙ₊₁, γₙ₊₂], 1≦n≦L=N. No payload bit is sent when γₘε[Γ₁, Γ₂] (e.g., physical-layer state s₁^{γ}^{ₘ}) to avoid deep channel fading. To meet the minimum PER requirement P₀, the SNR boundary set Γ can be computed by:

$$\{ \begin{matrix}{Γ}_{1} = 0 \\ {Γ}_{n + 1} = \frac{1}{{g}_{n}} ln ( \frac{{a}_{n}}{{P}_{0}} ) , n = 1 , 2 , … , N , \\ {Γ}_{N + 2} = ∞ .\end{matrix}$$

In an alternative embodiment, the present invention may be utilized in a MIMO system employing T transmit antennas and R receive antennas. For simplicity, it may be assumed T=R=M₀. Let H(iT_{F})=[h₁(iT_{F}), h₂(iT_{F}), . . . , h_{Mo}(iT_{F})] be the MIMO channel response matrix during each packet duration i, where hₘ(iT_{F}) denotes the m^{th} column of H(iT_{F}). A layered MIMO architecture may be transformed into spatially correlated parallel channels such that Hₘ(iT_{F})=[hₘ₊₁(iT_{F}), hₘ₊₂(iT_{F}), . . . , h_{Mo}

(iT_{F})]. At the receiver, the data transmitted from the M₀ transmit antennas (e.g., M₀ layers) are decoded separately and serially one by one. At each packet duration, the rate supported by layer m (over antenna m) is then given by:

$${C}_{m} = {log}_{2} ( 1 + {{h}_{m}^{H} ( {H}_{m} {H}_{m}^{H} + \frac{{M}_{0}}{ρ} {I}_{R} )}^{- 1} {h}_{m} ) = {log}_{2} ( 1 + {γ}_{m} ) ,$$

where ρ denotes the overall transmit SNR and thus γₘ=hₘ^{H}(HₘHₘ^{H}+T/ρI_{R})⁻¹hₘ, m=1, 2, . . . , M₀. For notational simplicity, the index of packet time t=iT_{F} is omitted above.

Treating each layer as one physical channel, the above layered MIMO system may be defined (e.g., determined, described, calculated, etc.) using the physical-layer Markov model shown in FIG. 9B, which is an extended version of the single physical channel model in FIG. 9A. Assuming each physical channel m has N=L+1 physical-layer states {s₁^{γm}, s₂^{γm}, . . . , s_{N}^{γm}}, the entire system has N_{γ}=N^{Mo}=(L+1)^{Mo} possible physical-layer state vectors, denoted as {s₁^{γ}, s₂^{γ}, . . . , s_{Nγ}^{γ}}, each of which is one physical-layer state for the entire system sₙ^{γ}={sₙ₁^{γ1}, sₙ₂^{γ2}, . . . , s_{nMo}^{γMo}}, n=1, 2, . . . , N_{γ}, where sₙₘ^{γm} indicates that the physical channel m falls in the nₘ^{th} physical-layer state, nₘ ε {1, 2, . . . , N} and m=1, 2, . . . , M₀. The steady-state probability of the above physical-layer MIMO model, π_{γ}=π₁^{γ}, π₂^{γ}, . . . , π_{N}_{_{γ}}^{γ}], is given by:

πₙ^{γ}=Pᵣ{Γₙ_{₁}≦γ₁<Γₙ_{₁}₊₁, Γₙ_{₂}≦γ₂<Γₙ_{₂}₊₁, . . . , Γₙ_{_{M}}_{₀}≦γ_{M}_{₀}<Γₙ_{_{M}}_{₀}₊₁},

where n=1, 2, . . . , N_{γ}. The one-step transition probability from sₙ^{γ} to sₙ^{γ} is T_{n,k}^{γ}=Pᵣ{sₖ^{γ} at time t+1|sₙ^{γ} at time t}. Thus, SNRs of different layers are correlated and the joint pdf of different γₘ is used in calculating the steady-state probability and the one-step state transition probability.

Given the parameters π_{γ} and T_{γ} of the physical-layer model in FIG. 9B, the state-transition probability matrix P for the packet-layer error model in FIG. 7 may be computed. Referring generally to FIG. 7, the one-step state transition probability sᵢ→sⱼ may be described as:

$${P}_{{s}_{i} , {s}_{j}} = {P}_{r} \{ {s}_{j} at t + 1 \text{\textbar} {s}_{i} at t \} = \frac{{P}_{r} \{ {s}_{j} at t + 1 , {s}_{i} t \}}{{P}_{r} \{ {s}_{i} at t \}} , i , j ∈ \{ 1 , 2 , … , {L}_{1} + {L}_{2} \} ,$$

where sᵢ and sⱼ denote packet-layer states, Pᵣ{sᵢ at t} is the joint probability of the events sᵢ=[s_{i,1}, s_{i,2}, . . . , s_{i,M}], and Pᵣ{sⱼ at t+1, sᵢ at t} is the joint probability of events sᵢ and sⱼ occurring in the two consecutive frame times t and t+1, respectively.

In yet another embodiment, the present invention may be utilized to determine a physical-layer Markov model for multicarrier systems (e.g., parallel ARQ over multicarrier correlated fading systems and/or OFDM systems). Consider a system containing M₀ parallel physical channels with i.i.d. (e.g., an OFDM system). As discussed with relation to MIMO systems above, such an system can also be described by the physical-layer Markov model shown in FIG. 9B. That is, each physical channel m has N states {s₁^{γm}, s₂^{γm}, . . . , s_{N}^{γm}}, m=1, 2, . . . , M₀, and the entire system has N_{γ}=N^{Mo} physical-layer states in total, {s₁^{γ}, s₂^{γ}, . . . , s_{N}_{_{γ}}^{γ}}, where sₙ^{γ}={sₙ₁^{γ1}, sₙ₂^{γ2}, . . . , s_{nMo}^{γMo}}, n=1, 2, . . . , N_{γ}, with sₙₘ^{γm} indicating that the physical channel m falls in the nₘ^{th} physical-layer state, nₘε{1, 2, . . . , N}. Then the corresponding steady-state probability π_{γ}=[π₁^{γ}, π₂^{γ}, . . . , π_{N}_{_{γ}}^{γ}], is given by:

$$\begin{matrix}{π}_{n}^{γ} = {P}_{r} \{ {Γ}_{{n}_{1}} \leq {γ}_{1} < {Γ}_{{n}_{1} + 1} , {Γ}_{{n}_{2}} \leq {γ}_{2} < {Γ}_{{n}_{2} + 1} , … , \\ {Γ}_{{n}_{{M}_{0}}} \leq {γ}_{{M}_{0}} < {Γ}_{{n}_{{M}_{0}} + 1} \} \\ = {\prod }_{m = 1}^{{M}_{0}} {P}_{r} \{ {Γ}_{{n}_{m}} \leq {γ}_{m} < {Γ}_{{n}_{m} + 1} \} \\ = {\prod }_{m = 1}^{{M}_{0}} {π}_{{n}_{m}}^{{γ}_{m}} , n = 1 , 2 , … , {N}_{γ} ,\end{matrix}$$

where nₘ ε {1, 2, . . . , N}. Thus, the one-step state transition probability sₙ^{γ}→sₖ^{γ}may be described as:

$$\begin{matrix}{T}_{n , k}^{γ} = {P}_{r} \{ {s}_{k}^{γ} at t + 1 \text{\textbar} {s}_{n}^{γ} at t \} \\ = {\prod }_{m = 1}^{{M}_{0}} {P}_{r} \{ {s}_{{k}_{m}}^{{γ}_{m}} at t + 1 \text{\textbar} {s}_{{n}_{m}}^{{γ}_{m}} at t \} \\ = {\prod }_{m = 1}^{{M}_{0}} {T}_{{n}_{m} , {k}_{m}}^{{γ}_{m}} , n , k = 1 , … , {N}_{γ} ,\end{matrix}$$

where πₙ_{ₘ}^{γ}^{ₘ} and Tₙ_{ₘ}_{,k}_{ₘ}^{γ}^{ₘ}, ∀nₘ, kₘ ε 1, 2, . . . , N}, may be analytically calculated, as above.

In some embodiments, the number of parallel physical channels in an multicarrier system may be large (e.g., M₀=128). Thus, the number of physical-layer states in the exemplary embodiment of FIG. 9B, N_{γ}=N^{Mo} is even more large. If each physical channel is treated as one logic channel as in FIG. 7 (e.g., M=M₀), the number of packet-layer states in FIG. 7, (L+1)^{M}, will also be very large. To make the analysis developed above tractable for multicarrier systems, the number of parallel logic channels may be reduced.

By grouping every “G” parallel physical channels into one equivalent physical channel which is treated as one parallel logic channel in FIG. 7 (e.g., M=M₀/G), the numbers of physical-layer states in FIG. 9B and packet-layer states in FIG. 7 then reduce to N_{γ}=N^{Mo/G}<<N^{Mo} and (L+1)^{Mo/G}<<(L+1)^{Mo}, respectively. For instance, for M₀=128 and G=32, N_{γ}=N⁴<<N¹²⁸ and (L+1)⁴<<(L+1)¹²⁸. Also, after grouping the M₀/G parallel logic channels, these channels remain statistically independent.

In still further embodiments, the present methods may be applied to determine a packet-layer error model for multicarrier systems. Similar to the discussion above for MIMO systems, given π_{γ} and T_{γ}, the state-transition probability matrix P for the packet-layer error model of multicarrier systems may also be computed using:

$$\begin{matrix}{P}_{{s}_{i} , {s}_{j}} = {P}_{r} \{ {s}_{j} at t + 1 \text{\textbar} {s}_{i} at t \} \\ = \frac{{P}_{r} \{ {s}_{j} at t + 1 , {s}_{i} t \}}{{P}_{r} \{ {s}_{i} at t \}} , i , j ∈ \{ 1 , 2 , … , {L}_{1} + {L}_{2} \} .\end{matrix}$$

Using the independence among different parallel channels, this may be expressed as:

$${P}_{{s}_{i} , {s}_{j}} = \frac{{\prod }_{m = 1}^{M} {P}_{r} \{ {s}_{j , m} at t + 1 , {s}_{i , m} t \}}{{\prod }_{m = 1}^{M} {P}_{r} \{ {s}_{i , m} at t \}} .$$

According to the definition of sᵢ above, the event s_{i,m}=0 corresponds to outage occurring over logic channel m, and the event s_{i,m}=1 corresponds to correct transmission occurring

over logic channel m with AMC mode 1, 1≦1≦L. The probability of the event s_{i,m} may be written as:

$${P}_{r} \{ {s}_{i , m} = 0 \} = {\sum }_{n = 1}^{N} {π}_{n}^{{γ}_{m}} {P}_{n}^{F} ( m ) , \\ {P}_{r} \{ {s}_{i , m} = l \} = {π}_{l - 1}^{{γ}_{m}} [ 1 - {P}_{l - 1}^{F} ( m ) ] , l = 1 , 2 , … , L$$

where πₙ^{γ}^{ₘ} is the steady-state probability of the physical-layer state n and P^{F}ₙ(m) is the corresponding average PER of state n over logic channel m, which can be expressed by:

$${P}_{n}^{F} ( m ) = \frac{1}{{π}_{n}^{{γ}_{m}}} {\int }_{{Γ}_{n}}^{{Γ}_{n + 1}} {P}_{n}^{F} ( γ ) {f}_{\tilde{γ m}} ( γ ) d γ , \\ n = 1 , 2 , … , n .$$

As such, the joint probability of events s_{i,m} and s_{j,m} occurring at time t ant t+1, respectively, may be calculated. For Rayleigh fading channel (e.g., exponentially distributed f_{\tilde{γ}m}(γ)), closed-form solutions are available and P can be analytically computed from

$${P}_{{s}_{i} , {s}_{j}} = \frac{{\prod }_{m = 1}^{M} {P}_{r} \{ {s}_{j , m} at t + 1 , {s}_{i , m} t \}}{{\prod }_{m = 1}^{M} {P}_{r} \{ {s}_{i , m} at t \}} .$$

The foregoing description discloses only particular embodiments of the invention, modifications and/or expansions of the above disclosed methods and apparatus which fall within the scope of the invention will be readily apparent to those of ordinary skill in the art. For instance, it will be understood that the invention may be employed in MIMO-OFDM systems and/or with alternative ARQ protocols and/or a combination of ARQ protocols. Further, it will be understood that though the particular steps of calculation may not be individually delineated, those calculations are inherent to the methods and determinations of the invention. Accordingly, while the present invention has been disclosed in connection with specific embodiments thereof, it should be understood that other embodiments may fall within the spirit and scope of the invention, as defined by the following claims.

What is claimed is:

1. A method of analyzing throughput of a parallel channel automatic-repeat-request system comprising:
determining a rate of a state of the automatic-repeat-request system;
defining a normalized throughput of the automatic-repeat-request system; and,
determining the normalized throughput of the automatic-repeat-request system based on the determined rate using a physical-layer Markov model.

2. The method of claim 1 further comprising determining parameters of the Markov model comprising:
determining a number of states;
defining the number of states;
determining a state transition probability matrix; and,
determining a steady state probability of the parallel channel automatic-repeat-request system using the determined state transition probability matrix.

3. The method of claim 1 wherein the automatic-repeat-request system uses a stop-and-wait automatic-repeat-request protocol.

4. The method of claim 1 wherein the automatic-repeat-request system uses a go-back-N automatic-repeat-request protocol.

5. The method of claim 1 wherein the automatic-repeat-request system uses a selective-repeat automatic-repeat-request protocol.

6. The method of claim 1 further comprising:
designing a packet-layer Markov model from parameters of the physical-layer Markov model and parameters of a transceiver comprising:
determining a set of physical-layer states based on the physical-layer Markov model;
determining a signal-to-noise ratio;
determining a signal-to-noise ratio boundary set for the signal-to-noise ratio; and,
producing a packet-layer model using the signal-to-noise ratio and the signal-to-noise ratio boundary set.

7. The method of claim 6 wherein model describes a correlated fading channel.

8. The method of claim 6 wherein model describes a MIMO system.

9. The method of claim 6 wherein model describes a OFDM system.

10. The method of claim 6 wherein determining a signal-to-noise ratio boundary set comprises computing the signal-to-noise ratio boundary set from known packet-error-ratio approximation parameters.

11. The method of claim 10 wherein computing the signal-to-noise ratio boundary set from known packet-error-ratio approximation parameters comprises computing:
$$\{ \begin{matrix}{Γ}_{1} = 0 , \\ {Γ}_{n + 1} = \frac{1}{{g}_{n}} ln ( \frac{{a}_{n}}{{P}_{0}} ) , n = 1 , 2 , … , N , \\ {Γ}_{N + 2} = ∞\end{matrix}$$
wherein {Γ₁, Γ₂, . . . , Γ_{N+1}} is a set of signal-to-noise ratio thresholds;
Pₒ is a minimum packet-error-ratio requirement; and,
aₙ and gₙ are parameters of a packet-error-ratio curve.

12. A method of analyzing throughput of a parallel channel automatic-repeat-request system comprising:
designing a packet-layer Markov model comprising:
determining a set of physical-layer states;
determining a signal-to-noise ratio;
determining a signal-to-noise ratio boundary set for the signal-to-noise ratio; and,
producing a packet-layer Markov model using the signal-to-noise ratio and the signal-to-noise ratio boundary set; and,
determining a throughput of the automatic-repeat-request system using the packet-layer Markov model.

13. The method of claim 12 wherein model describes a correlated fading channel.

14. The method of claim 12 wherein model describes a MIMO system.

15. The method of claim 12 wherein model describes a OFDM system.

16. The method of claim 12 wherein determining a signal-to-noise ratio boundary set comprises computing the signal-to-noise ratio boundary set from known packet-error-ratio approximation parameters.

17. The method of claim 16 wherein computing the signal-to-noise ratio boundary set from known packet-error-ratio approximation parameters comprises computing:
$$\{ \begin{matrix}{Γ}_{1} = 0 , \\ {Γ}_{n + 1} = \frac{1}{{g}_{n}} ln ( \frac{{a}_{n}}{{P}_{0}} ) , n = 1 , 2 , … , N , \\ {Γ}_{N + 2} = ∞\end{matrix}$$
wherein {Γ₁, Γ₂, . . . , Γ_{N+1}} is a set of signal-to-noise ratio thresholds;
Pₒ is a minimum packet-error-ratio requirement; and,
aₙ and gₙ are parameters of a packet-error-ratio curve.

18. A system for data transmission comprising:
a transmitter adapted to transmit transmission signals over a plurality of parallel channels in an orthogonal-frequency-division-multiplexing system according to an automatic-repeat-request protocol; and,
a receiver adapted to receive the transmission signals from the transmitter over the plurality of parallel channels.

19. The system of claim 18 further comprising:
a buffer in communication with the transmitter and adapted to buffer the signals prior to transmission over the plurality of parallel channels according to the automatic-repeat-request protocol.

20. The system of claim 18 further comprising:
one or more backward channels adapted to transmit one or more feedback signals from the receiver to the transmitter in response to the transmission signals transmitted over the plurality of parallel channels.

21. The system of claim 20 further comprising:
a buffer in communication with the receiver and adapted to buffer the feedback signals prior to transmission over the plurality of parallel channels according to the automatic-repeat-request protocol.

22. A method of operation of a transmitter in a orthogonal-frequency-division-multiplexing data transmission system comprising:
transmitting a plurality of packets from a transmitter to a receiver over a plurality of parallel channels using an automatic-repeat-request protocol; and,
receiving from the receiver one of a positive acknowledgment or a negative acknowledgement for each of the plurality of packets.

23. The method of claim 22 wherein the automatic-repeat-request protocol is stop-and-wait.

24. The method of claim 22 wherein the automatic-repeat-request protocol is go-back-N.

25. The method of claim 22 wherein the automatic-repeat-request protocol is selective-repeat.
